(19) United States
(12) Patent Application Publication
(10) Pub. No.: US 2004/0174836 A1
(43) Pub. Date: Sep. 9, 2004

(54) Method for controlling the operating point of a transistor of a power amplifyer

(75) Inventor: Rolf Nuchter, Fellbach (DE)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 10/760,308

(22) Filed: Jan. 21, 2004

(30) Foreign Application Priority Data
Mar. 3, 2003 (EP) 03 290 496.3

(51) Int. Cl. H04B 7/185

(52) U.S. Cl. 370/318; 370/345

(57) ABSTRACT

The invention relates to a method for controlling the operating point of a transistor of a power amplifier for amplifying time division multiplex (access) TDM(A)-signals. Methods to compensate drifts of the operating point caused by temperature variations are in principle known in the art. However, the methods known in the art have the disadvantage that they are not precise enough during the operation of such power amplifiers, in particular when amplifying high-frequency TDM(A)-signals. In order to overcome said problem the invention proposes to carry out the controlling of the operating point during null power time slots of said TDM-signal.

### TECHNICAL FIELD

The invention relates to a method for controlling the operating point of a transistor of a power amplifier for amplifying time division multiplex (access) TDM(A)-signals.

The invention further relates to a computer program for carrying out said method, a power amplifier comprising a transistor the operating point of which is controlled, a transmitter comprising such a power amplifier, a transmitting station comprising at least one of said transmitters and a telecommunications system comprising at least one of said power amplifiers. The invention is based on a priority application EP 03 290 496.3 which is hereby incorporated by reference.

### BACKGROUND OF THE INVENTION

In the prior art methods for controlling the operating point of a transistor of a power amplifier are known, e.g. from U.S. Pat. No. 5,426,641. Said US-patent discloses an amplifier for TDMA wireless communications systems. The operating point of such amplifiers typically drifts with respect to temperature variations. In order to maintain the amplifier at a proper bias level over changing temperature conditions and free from effects of device aging and device to device variations that US patent teaches to monitor the drain current of the amplifier each frame outside a burst interval in which a portable is transmitting, i.e. when no signal is present at the amplifiers input. The drain current is controlled by adjusting the gate voltage to compensate for any variations. In particular said adjustment comprises the steps for measuring the drain current representing an actual operating point of the amplifier, in particular a transistor, with a desired value, representing a set operating point and adjusting the gate voltage with respect to the result of said comparison. According to the disclosure of this US patent all of these steps, in particular the measuring, comparing and adjusting steps are carried out all together within one null power time slot.

Starting from that prior art it is the object of the present invention to improve a known method for controlling the operating point of a transistor of a power amplifier, a computer program for carrying out said method, a power amplifier comprising such a transistor, a transmitter comprising such a power amplifier, a transmitting station comprising at least one of said transmitters and a telecommunications system comprising at least one of said power amplifiers such that the controlling of the operating point can be carried out in a cheaper manner.

This object is solved by the method for controlling the operating point of a transistor of a power amplifier (100) for amplifying time division multiplex (access) TDM(A)-signals, comprising the steps of: detecting a deviation between a set operating point and an actual operating point of said transistor (110); detecting the occurrence of said null power time slots (nⱼ) or using the knowledge when they occur; and adjusting the bias of the gate/base of said transistor (110) according to said deviation in order to re-establish said set operating point; wherein these steps are carried out during separate null power time slot (nⱼ) of said TDM(A)-signals. That method is characterized in that the steps of detecting a deviation between a set operating point and an actual operating point of said transistor and of adjusting the bias of the gate/base of said transistor according to said deviation in order to re-establish said set operating point are carried out during separate individual null power time slots of a TDM(A) signal.

A null power time slot in the meaning of the invention is a time slot with very low, in particular with null signal power.

Advantageously, the execution of the steps in separate time slots enables the execution of the method by using slower and thus cheaper hardware equipment.

### SUMMARY OF THE INVENTION

Another advantage of the proposed solution lies in the fact that the controlling of the operating point of the transistor, i. e. the detection of a deviation between the set operating point and the actual operating point and the adjustment of the bias is not disturbed by HF-signals amplified by the power amplifier. Consequently, a more precise re-establishment of the set operating point is possible. Furthermore, the adjustment itself does not impact the HF-signal if the adjustment is done in the time where no HF-signal is applied to the transistor.

According to a preferred embodiment of said method the single steps necessary for controlling the operating point are carried out during different null power time slots comprised within said TDM(A)-signal. It is not strictly necessary that these time slots occur consecutively; the controlling of the operating point according to the claimed method is also possible during several time slots which do not occur consecutively. However, the single time slots used for carrying out the controlling of the operating point preferably occur within a time interval being much shorter than the time constant of the temperature variations causing the drift of the operating point.

According to another preferred embodiment of the present invention the adjustment of the bias is carried out iteratively during several control loops.

Further, in order to ensure a precise controlling of the operating point the controlling is done only after the transistor has reached a steady state with respect to its temperature after the power amplifier has been switched on. To make sure that the steady state has been reached the controlling operation is for example started after N null power time slots with N e. g. greater than 3, have occurred within said TDM(A)-signal.

Further advantageous embodiments of the method are subject-matters of the dependent claims.

The above-identified object is further solved by a computer program for a controlling unit of a power amplifier comprising a code being adapted to carry out the method according to the invention when running on a microprocessor. Further, the above-identified object is solved by a power amplifier for amplifying TDM(A)-signals, by a transmitter comprising such a power amplifier, by a transmitting station comprising such a transmitter and by a telecommunications system comprising such amplifiers. The advantages of said solutions correspond to the advantages outlined above with respect to the claimed method.

### BRIEF DESCRIPTION OF THE DRAWINGS

In the following different embodiment of the invention are described in detail by referring to the accompanying figures, wherein

FIG. 1 shows a power amplifier;

FIG. 2 shows a TDM(A)-signal; and

FIG. 3 shows a transmitter, a transmitting station and a telecommunications system.

### DETAILED DESCRIPTION OF PREFERRED EMBODIMENTS

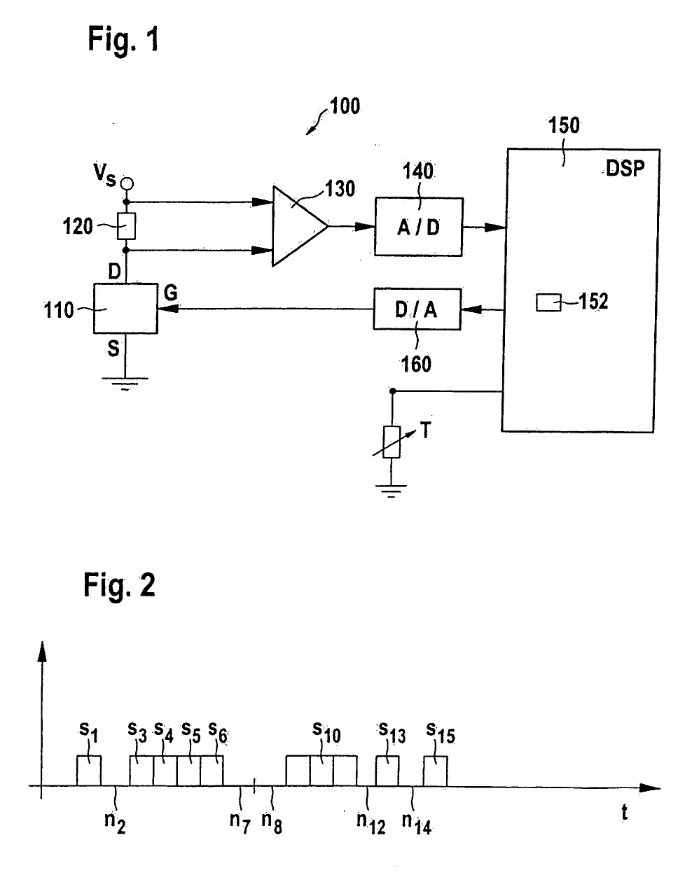

FIG. 1 shows a power amplifier 100 for amplifying time division multiplex (access) TDM(A)-signals in a TDM(A) system, in particular in a Global System for Mobile communications GSM.

FIG. 2 shows an example for such a TDM(A)-signal comprising data time slots sᵢ with i=1, 3-6, 9-11, 13and 15 and null power time slots nⱼ with j=2, 7, 8, 12 and 14.

The power amplifier 100 shown in FIG. 1 comprises a transistor 110 for amplifying said TDM(A)-signals. Said transistor may be embodied as bipolar transistor but is preferably embodied as field effect transistor FET-transistor having a source S, a gate G and a drain D. The drain source-connection of said FET-transistor is connected in series with a shunt 120 and said series connection is connected to a power supply voltage Vs. The measurement voltage dropping across said shunt 120 is input to an operational amplifier 130. Said operational amplifier 130 outputs an analog signal representing the value of said measurement voltage. Said analog signal is digitized by an analog/digital converter 140 before being input into a controlling unit 150.

Said controlling unit is preferably embodied as digital signal processor DSP. Said signal input to said signal processor 150 represents the actual operating point of the transistor 110. The controlling unit compares said actual operating point with a predefined set operating point for said transistor 110. In the case that a deviation between said set operating point and the actual operating point is detected, the controlling unit 150 outputs a control signal via a digital/analog converter 160 to the gate of said transistor 110. The control signal is typically a gate voltage. It serves for adjusting the bias of the gate of the transistor according to the detected deviation in order to re-establish the set operating point.

According to the invention the controlling unit 150 is embodied to carry out the detection of the deviation and the adjusting of the bias, i. e. the controlling of the operating point of the transistor only during null power time slots occurring within said TDM(A)-signal. Advantageously, the controlling unit is further embodied to detect the occurrence of said null power time slots nⱼ.

The controlling unit 150 is preferably embodied to carry out the controlling of the operating point during several null power time slots which do not necessarily occur consecutively within said TDM(A)-signal. More specifically, the controlling unit 150 may detect the occurrence of said null power time slots within a first one of said null power time slots, may adjust the bias within a second of said null power time slots and may optionally check the adjustment of the bias within a third one of said null power time slots. More generally, the detection of null power slots can be done by the said detection or may be already controlled/known by the controlling unit.

In the case that the null power time slots used for controlling the operating point do not occur consecutively they should occur within a time interval being much shorter than the time constant of the temperature variations causing the drift of the operating point.

The adjustment of the bias may not be done within one control loop but may be carried out iteratively during several control loops.

The method for controlling the operating point of the transistor according to the present invention is preferably carried out by a computer program for the controlling unit 150 when running on a microprocessor 152 of said controlling unit. In the case of such a software-solution the computer program may—perhaps together with other computer programs of the controlling unit—be stored on a computer-readable storage medium, e. g. a disc, a compact disc or a flash memory. When the computer program is stored on such a storage medium it may be sold to customers.

Another possibility to transmit the computer program to customers is its transmission via a communications network, in particular the Internet. In that case, no storage medium is necessary.

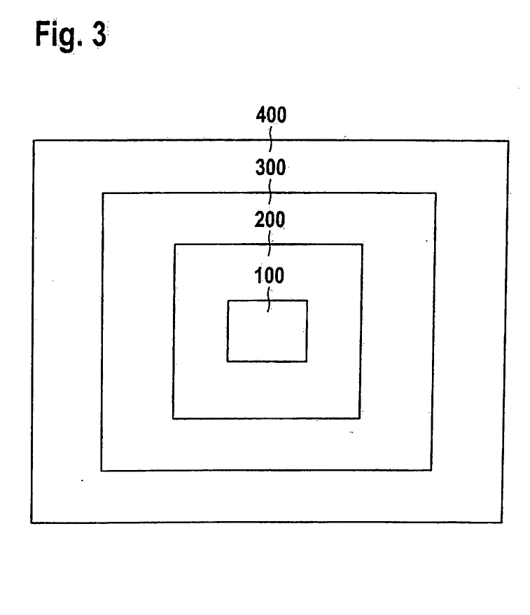

As shown in FIG. 3, the power amplifier according to the invention may be comprised within a transmitter 200, in particular a radio transmitter. The power amplifier or the transmitter may be part of a transmitting station 300, in particular a radio transmitting base station. Finally, the claimed power amplifier, the transmitter or the transmitting station may be part of a telecommunications system 400, in particular a mobile radio system.

1. Method for controlling the operating point of a transistor of a power amplifier for amplifying time division multiplex (access) TDM(A)-signals, comprising the steps of:
detecting a deviation between a set operating point and an actual operating point of said transistor;
detecting the occurrence of said null power time slots or using the knowledge when they occur; and
adjusting the bias of the gate/base of said transistor according to said deviation in order to re-establish said set operating point;
wherein
these steps are carried out during separate null power time slot of said TDM(A)-signals.

2. Method according to claim 1, wherein the step of adjusting the bias optionally comprises the substep of:
checking the adjustment of the bias.

3. Method according to one of the preceding claims, wherein the null power time slots to be used arise consecutively or not within said TDM(A)-signal.

4. Method according to one of the preceding claims, wherein the adjustment of the bias is carried out iteratively during several control loops.

5. Method according to one of the preceding claims, wherein the set operating point is adapted in response to the temperature in the surrounding of the transistor.

6. Method according to one of the preceding claims, wherein bias means the gate/base voltage for driving the gate/base of the transistor.

7. Method according to one of the preceding claims, wherein the controlling of the operating point of the transistor is done only after the transistor has reached a steady state with respect to its temperature after a switch-on of the power amplifier.

8. Method according to claim 7, wherein the controlling of the operating point is started after N, e. g. N=3, null Power time slots have occurred.

9. Computer program for a controlling unit of a Power amplifier, comprising code being adapted to carry out the method according to one of claims 1-8 when running on a microprocessor.

10. Computer program according to claim 9, wherein the code is stored on a computer-readable storage medium.

11. Power amplifier for amplifying time division multiplex (access) TDM(A)-signals in a TDM(A) system, in particular in a Global System for Mobile Communications GSM, comprising
a transistor for amplifying said TDM(A)-signals;
a shunt being connected in series to the drain-source path or collector-emitter path of said transistor for providing a measurement voltage, the constant component of which representing the actual operating point of said transistor; and
a controlling unit for detecting a deviation between a set operating point and said actual operating point, for detecting the occurrence of null power time slots within said TDM(A)-signals and for adjusting the bias of the gate/base of said transistor according to said deviation in order to re-establish said set operating point;
wherein
the controlling unit is embodied to carry out the detecting and adjusting steps during separate ones of said detected null power time slots.

12. Power amplifier according to claim 11, wherein the controlling unit is embodied as a digital signal processor.

13. Transmitter, in particular a radio transmitter, comprising a power amplifier according to claims 11 or 12.

14. Transmitter station, in particular a radio transmitting base station, comprising at least one transmitter according to claim 13.

15. A telecommunications system, in particular a mobile radio system, comprising at least one power amplifier according to one of claims 11 or 12.
